(19) United States
(12) Patent Application Publication
(10) Pub. No.: US 2008/0078427 A1
(43) Pub. Date: Apr. 3, 2008

(54) SUBSTRATE CLEANING METHOD AND SEMICONDUCTOR DEVICE MANUFACTURING METHOD

(76) Inventor: Kentaro MATSUNAGA, Kawasaki-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/865,901

(22) Filed: Oct. 2, 2007

(30) Foreign Application Priority Data
Oct. 2, 2006 (JP) 2006-271072

(51) Int. Cl. B08B 3/02; B08B 3/00

(52) U.S. Cl. 134/33

(57) ABSTRACT

According to an aspect of the invention, there is provided a substrate cleaning method of discharging cleaning liquid from a nozzle above a processing target substrate to clean the substrate while rotating the substrate such that the nozzle is scanned from the center of the substrate toward an outside of the substrate while discharging the cleaning liquid from the nozzle toward the substrate to scatter the cleaning liquid toward the outside of the substrate, comprising controlling a flow rate of the cleaning liquid, a rotational speed of the substrate, a scan speed of the nozzle, and a scan start position of the nozzle such that the cleaning liquid discharged from the nozzle does not impinge on the old cleaning liquid remaining on the substrate when the cleaning liquid discharged from the nozzle contacts a surface of the substrate.

### CROSS-REFERENCE TO RELATED APPLICATIONS

This application is based upon and claims the benefit of priority from prior Japanese Patent Application No. 2006-271072, filed Oct. 2, 2006, the entire contents of which are incorporated herein by reference.

### BACKGROUND OF THE INVENTION

1. Field of the Invention

The present invention relates to a substrate cleaning method and, more particularly, to a method of cleaning a substrate before or after exposure by an immersion exposure apparatus in a lithography step of a semiconductor device manufacturing process.

2. Description of the Related Art

The upper and lower surfaces of a processing target substrate sometimes get wet by micropattern exposure using an immersion exposure apparatus in a semiconductor lithography technique. If the substrate surfaces are left wet without removing the droplets from them, the droplets dry on the substrate surfaces and hence leave marks (watermarks) on the substrate surfaces upon vaporization.

In a lithography step of a conventional semiconductor device manufacturing process, an antireflection film, resist, and immersion protective film are applied on the surface of a processing target substrate in the order named. Alternatively, a transfer Film, spin-on-glass (SOG) film, resist, and immersion protective film are applied on the surface of a processing target substrate in the order named.

However, when the immersion protective film dries, a residual droplet on it permeates through the immersion protective film and reaches the resist. The droplet having reached the resist makes the distribution of a film of an acid-forming agent Quencher in the resist nonuniform. When a pattern is formed through a post-exposure bake (PEB) step, immersion protective film removal step, and development step, its size may fall outside a desired one, it may have a bird's beak cross section, or no pattern may be formed within the watermark range. This significantly degrades the yield of semiconductor device manufacture.

If the lower surface of the substrate is wet, dirt on the lower surface, edge, or beveled portion of the substrate adheres on a baker as a contaminant via the droplet in the PEB step. The contaminants accumulated with an increase in the number of processed substrates adhere on the surfaces of other substrates. This may cause defects to result in a decrease in yield.

To improve the yield in a lithography step using immersion exposure, it is necessary to clean the upper and lower surfaces of the substrate after immersion exposure to remove the droplets and contaminants from them.

A cleaning apparatus may be used in the semiconductor front-end process as a technique of cleaning a substrate in the semiconductor device manufacturing process. However, since a cleaning unit of the cleaning apparatus is large and expensive, it is difficult to build it into a conventional exposure apparatus or coating/developing apparatus. In view of this, the following methods are proposed.

In a developing unit built into a conventional coating/developing apparatus, a substrate was cleaned using a method of discharging cleaning liquid from a nozzle onto the substrate using a rinse method after development, and spinning the substrate 1,000 to 2,000 times per second to scatter the cleaning liquid outside the substrate, thereby drying the substrate. In this case, several hundreds to several thousands of minute watermarks remained on the upper and lower surfaces of the substrate as defects. In spite of cleaning, defects could not be decreased.

In the rinse step after development, a scan rinse method of scattering cleaning liquid outside a substrate while discharging it in the circumferential direction from the central portion of the substrate at a constant speed was applied to the above-described substrate cleaning. In the above-described method of rotating a substrate 1,000 times or more per second to scatter cleaning liquid, several hundreds or several thousands of minute watermarks remained on the upper and lower surfaces of the substrate as defects, similar to the above case.

This result revealed that even though the substrate was cleaned at a rotation speed equal to or less than 500 rotations per second at which cleaning liquid is not scattered, the cleaning liquid discharged from the nozzle lingered on the rotating substrate. The lingering cleaning liquid impinged on a newly discharged cleaning liquid. This resulted in disturbance of the cleaning liquid flow, leaving watermarks on the substrate.

Jpn. Pat. Appln. KOKAI Publication No. 2004-335542 discloses an arrangement in which the surfaces of a substrate are cleaned by scanning from its center toward its outside.

### BRIEF SUMMARY OF THE INVENTION

According to an aspect of the invention, there is provided a substrate cleaning method of discharging cleaning liquid from a nozzle above a processing target substrate to clean the substrate while rotating the substrate such that the nozzle is scanned from the center of the substrate toward an outside of the substrate while discharging the cleaning liquid from the nozzle toward the substrate to scatter the cleaning liquid toward the outside of the substrate, comprising; controlling a flow rate of the cleaning liquid, a rotational speed of the substrate, a scan speed of the nozzle, and a scan start position of the nozzle such that the cleaning liquid discharged from the nozzle does not impinge on the old cleaning liquid remaining on the substrate when the cleaning liquid discharged from the nozzle contacts a surface of the substrate.

According to another aspect of the invention, there is provided a semiconductor device manufacturing method of manufacturing a semiconductor device using a processing target substrate which is cleaned by rotating the substrate such that the nozzle is scanned from the center of the substrate toward an outside of the substrate while discharging the cleaning liquid from the nozzle toward the substrate to scatter the cleaning liquid toward the outside of the substrate, comprising; controlling a flow rate of the cleaning liquid, a rotational speed of the substrate, a scan speed of the nozzle, and a scan start position of the nozzle such that the cleaning liquid discharged from the nozzle does not impinge on the old cleaning liquid remaining on the substrate when the cleaning liquid discharged from the nozzle contacts a surface of the substrate; and manufacturing the semiconductor device using the cleaned substrate.

### BRIEF DESCRIPTION OF THE SEVERAL VIEWS OF THE DRAWING

FIG. 1 is a view showing a substrate cleaning method according to the embodiment;

FIG. 2 is a view showing the substrate cleaning method according to the embodiment;

FIG. 3 is a flowchart showing a semiconductor manufacturing process according to the embodiment;

FIG. 4 is a view showing a trace of cleaning liquid according to the embodiment;

FIG. 5 is a graph showing the relation between the hydraulic jump radius and the flow rate according to the embodiment;

FIG. 6 is a graph showing the relation between the hydraulic jump radius and the rotational speed according to the embodiment;

FIG. 7 is a graph showing the relation between the scan start position and the hydraulic jump radius according to the embodiment;

FIG. 8 is a graph showing the relation between the scan speed and the rotational speed according to the embodiment; and

FIG. 9 is a view showing a trace of cleaning liquid according to the embodiment;

### DETAILED DESCRIPTION OF THE INVENTION

Embodiments of the present invention will be described below with reference to the accompanying drawing.

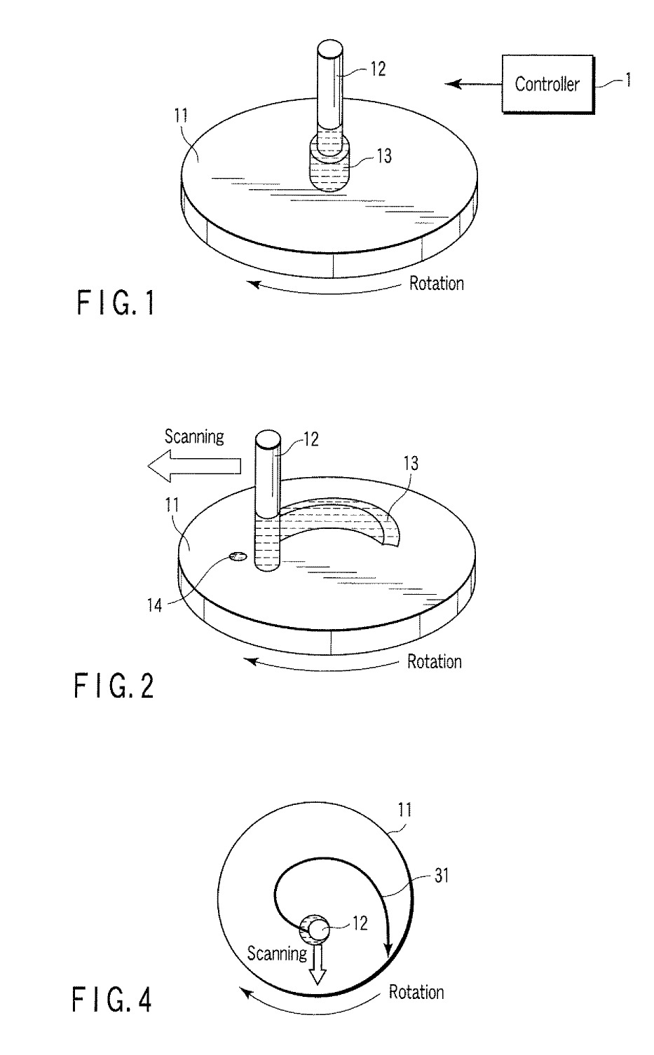

FIG. 1 is a view showing a substrate cleaning method according to the first embodiment. The substrate cleaning method is performed under the control of a control unit 1 in a substrate cleaning apparatus. As shown in FIG. 1, in the process of cleaning a processing target substrate 11 such as a semiconductor wafer, cleaning liquid 13 is discharged from a nozzle 12 above the processing target substrate 11 to clean and dry the substrate 11 while rotating it.

In this process, as shown in FIG. 2, the nozzle 12 is scanned from the center toward the outside of the substrate while discharging the cleaning liquid 13 from the nozzle 12 to the substrate 11 to scatter the cleaning liquid 13 outside the substrate 11 while collecting a residual droplet 14 on the substrate 11 on its way. With this operation, the substrate 11 is cleaned and dried without leaving any droplets behind on it.

The cleaning liquid 13 discharged from the nozzle 12 scatters while migrating on the substrate 11 in accordance with the rotation of the substrate 11. At this time, the flow rate of the cleaning liquid 13, the rotational speed of the substrate 11, and the scan speed and scan start position of the nozzle 12 are controlled so that the old cleaning liquid 13 lingering on the rotating substrate 11 does not impinge on cleaning liquid 13 newly discharged from the nozzle 12. With this operation, the substrate 11 is cleaned and dried without leaving any droplets behind on it.

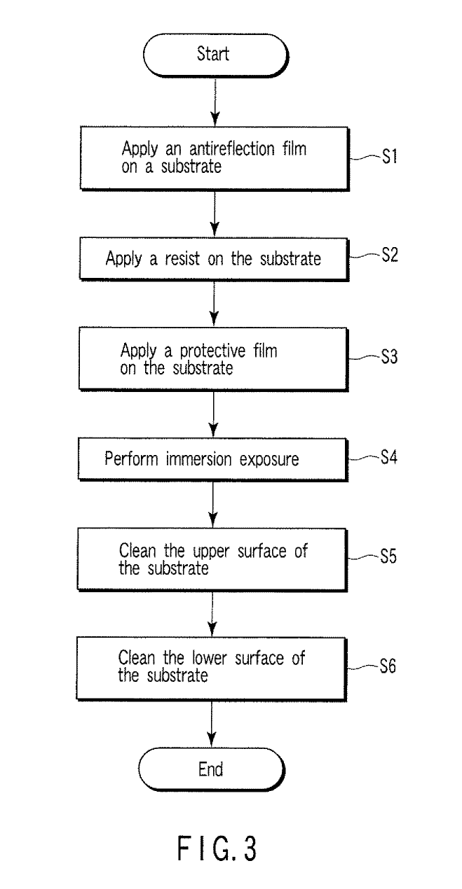

FIG. 3 is a flowchart showing a semiconductor manufacturing process according to the first embodiment. First, in a lithography step of forming a micropattern in a semiconductor device manufacturing process, in step S1, a coating/developing apparatus applied a 77-nm-thick antireflection film ARC29A (manufactured by Nissan Chemical Industries, Ltd.) on a processing target substrate. The substrate was then baked at 205° C. for 60 seconds and cooled. In step S2, the coating/developing apparatus applied a 150-nm-thick resist AR2014J (manufactured by JSR) on the substrate. The substrate was then baked at 115° C. for 60 seconds and cooled. In step S3, the coating/developing apparatus applied a 90-nm-thick protective film TCX015 (manufactured by JSR) on the substrate. The substrate was then baked at 90° C. for 60 seconds. In step S4, this substrate was conveyed to an ArF immersion exposure apparatus in-line connected to the coating/developing apparatus via an interface unit to perform immersion exposure.

After immersion exposure, five 0.5-mm-diameter droplets and one 1-mm-diameter droplet remained on the upper surface of the substrate, while two 2-mm-diameter droplets and three 1-mm-diameter droplets remained on the lower surface of the substrate, while being spaced apart from its outer periphery by 2 and 1 mm, respectively. This substrate was conveyed to a cleaning unit built into the coating/developing apparatus during 90 seconds until the droplets on its upper and lower surfaces disappeared upon vaporization.

First, in step S5, the upper surface of the substrate is cleaned. When the protective film had a static contact angle of 78°, the cleaning liquid was ultra-pure water, and the flow rate of the cleaning liquid was 0.5 L/min, the cleaning liquid discharged from a nozzle caused a hydraulic jump phenomenon on the substrate. Since the region suffering the hydraulic jump phenomenon had a radius (hydraulic jump radius) of 8 mm, a scan start position Rs0 of the nozzle was is spaced apart from the center by 5 mm, that was proportional to a hydraulic jump radius Rj (Rs0∝Rj).

A nozzle scan speed Vs was proportional to the product of the hydraulic jump radius Rj and a rotational speed nrev of the wafer (substrate) per unit time (Vs∝Rj×nrev). If the rotational speed nrev of the substrate is 100 rpm, it suffices to clean the substrate surfaces with scanning using the nozzle at a constant speed Vs=8.3 mm/s. In this case, the cleaning liquid scattered outside the substrate along a trace (31) as shown in FIG. 4. In this step, cleaning and drying were performed without leaving any watermarks on the substrate surfaces.

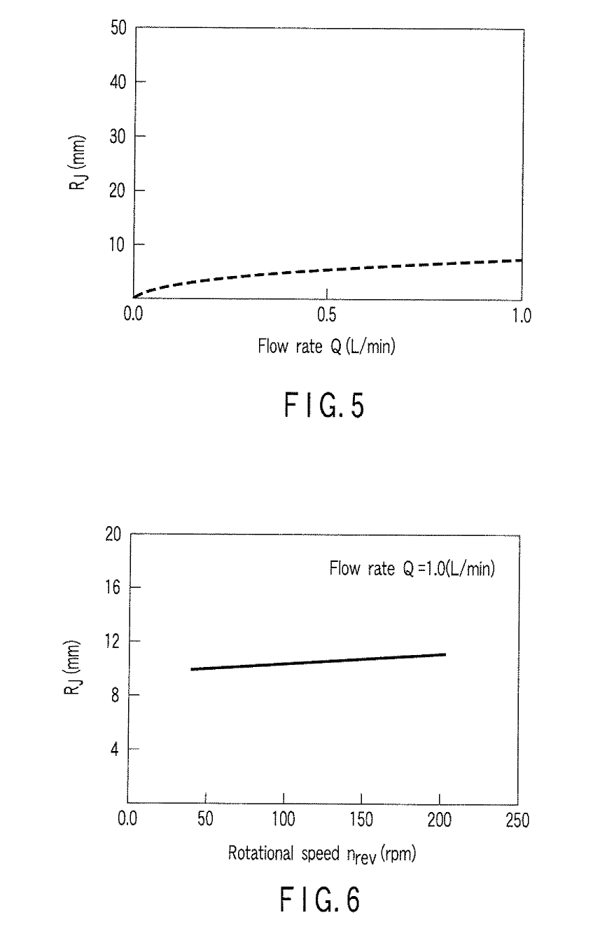

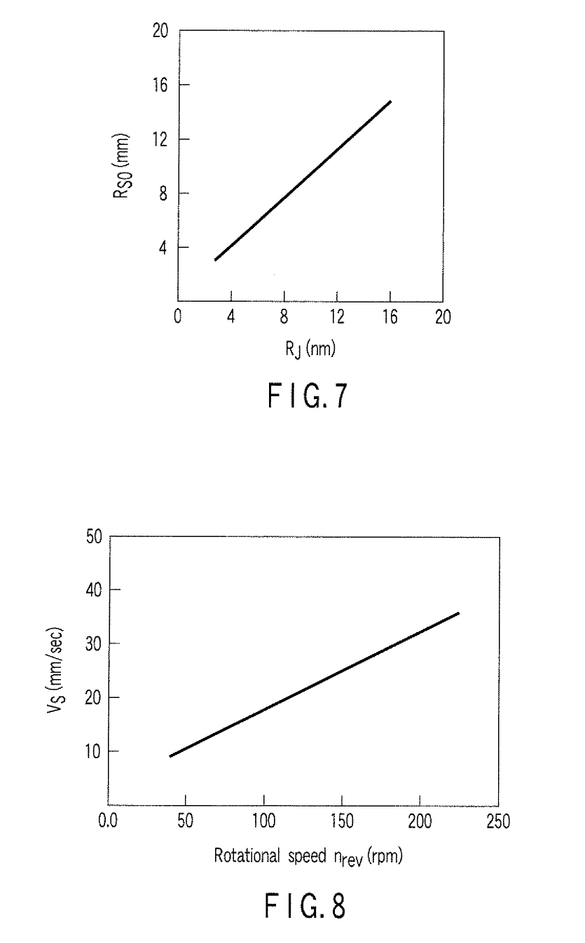

The parameters in this case were determined as follows. FIG. 5 shows the relation between the hydraulic jump radius Rj (=Rj(Q)) and the flow rate Q. When no cleaning liquid was discharged to the central portion of the rotating substrate as in this embodiment, the hydraulic jump radius Rj hardly depended on the flow rate Q. As shown in FIG. 6, the hydraulic jump radius Rj was determined virtually independently of the rotational speed nrev. As shown in FIG. 7, the scan start position Rs0 and the hydraulic jump radius Rj satisfied Rs0=βRj (β−1).

The scan speed Vs was determined as follows. As shown in FIG. 8, the higher the rotational speed nrev of the substrate, the higher the necessary scan speed Vs. The lower the rotational speed nrev, the lower the necessary scan speed Vs.

Next, in step S6, the lower surface of the substrate is cleaned. Simultaneously with the cleaning of the upper surface of the substrate, the lower surface of the substrate was cleaned by discharging cleaning liquid from a nozzle for cleaning the lower surface, which was spaced apart from the outer periphery of the substrate by 30 mm, toward the lower surface of the substrate at a flow rate of 0.5 L/min.

This cleaning completely removed the droplets on the lower surface of the substrate. The substrate with the lower surface free from any contaminants was conveyed to a PEB step. In the PEB step, the substrate was baked at 115° C. for 60 seconds, cooled, and conveyed to a development step. In the development step, development was performed for 60 seconds using a 2.38-wt % tetramethylammonium hydroxide (TMAH) solution as a developer. With the above-described steps, a 55-nm line-and-space pattern free from defects was formed. Finally, a semiconductor device is manufactured by using the semiconductor substrate cleaned as described above.

Although the first embodiment has exemplified substrate cleaning after immersion exposure in the lithography step of the semiconductor device manufacturing process, the present invention is limited to neither cleaning after exposure nor the lithography step.

In the following second embodiment, the same materials were stacked on the same substrate as in the first embodiment. An ArF immersion exposure apparatus then performed immersion exposure.

After immersion exposure, droplets remained on the upper and lower surfaces of the substrate, as in the first embodiment. Since the same protective film as in the first embodiment was applied on the substrate, a hydraulic jump radius Rj was 6 mm when the protective film had a static contact angle of 78°, the cleaning liquid was ultra-pure water, and the flow rate of the cleaning liquid was 0.25 L/min. Hence, a scan start position Rs0 was spaced apart from the center by 4 mm, that was proportional to a hydraulic jump radius Rj (Rs0∝Rj).

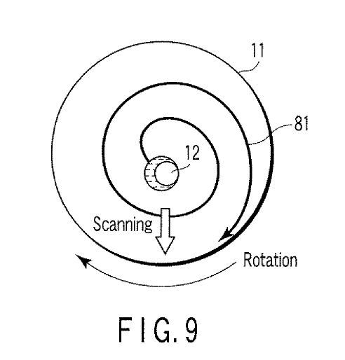

A scan speed Vs was proportional to the product of the hydraulic jump radius Rj and a rotational speed nrev of the wafer (Vs∝Rj×nrev). If the rotational speed nrev of the substrate is 100 rpm, it suffices to clean the substrate surfaces with scanning using a nozzle at a constant speed Vs=40 mm/s. In this case, the cleaning liquid scattered outside the substrate along a trace (81) as shown in FIG. 9. In this step, cleaning and drying were performed without leaving any watermarks on the substrate surfaces.

Simultaneously with the cleaning of the upper surface of the substrate, the lower surface of the substrate was cleaned by discharging cleaning liquid from a nozzle for cleaning the lower surface, which was spaced apart from the outer periphery of the substrate by 30 mm, toward the lower surface of the substrate at a flow rate of 0.5 L/min, as in the first embodiment.

This cleaning in conditions different from those of the first embodiment completely removed the droplets on the lower surface of the substrate. The substrate with the lower surface free from any contaminants was conveyed to a PEB step. A 55-nm line-and-space pattern free from defects was formed through the same steps as in the first embodiment. Finally, a semiconductor device is manufactured by using the semiconductor substrate cleaned as described above.

Although the substrate was cleaned after immersion exposure in the first embodiment, the following third embodiment will exemplify a method of performing cleaning even before immersion exposure.

As in the first embodiment, a coating/developing apparatus applied an 80-nm-thick antireflection film ARC29A (manufactured by Nissan Chemical Industries, Ltd.) on a processing target substrate. The substrate was then baked at 205° C. for 60 seconds and cooled. The coating/developing apparatus applied a 150-nm-thick resist AR2014J (manufactured by JSR) on the substrate. The substrate was then baked at 115° C. for 60 seconds and cooled. The coating/developing apparatus applied a 90-nm-thick protective film TCX026 (manufactured by JSR) on the substrate. The substrate was then baked at 90° C. for 60 seconds. This substrate was conveyed to a cleaning unit.

Since the same protective film as in the first embodiment was applied on the substrate, cleaning liquid discharged from a nozzle caused a hydraulic jump phenomenon when the protective film had a static contact angle of 78°, the cleaning liquid was ultra-pure water, and the flow rate of the cleaning liquid was set at 0.5 L/min. Since the region suffering the hydraulic jump phenomenon had a radius (hydraulic jump radius) of 8 mm, a scan start position Rs0 was spaced apart from the center by 5 mm, that was proportional to a hydraulic jump radius Rj (Rs0∝Rj).

A scan speed Vs was proportional to the product of the hydraulic jump radius Rj and a rotational speed nrev of the wafer (Vs∝Rj×nrev). If the rotational speed nrev of the substrate is 150 rpm, it suffices to clean the substrate surfaces with scanning using a nozzle at a constant speed Vs=12.45 mm/s. In this case, the cleaning liquid scattered outside the substrate along a trace (31) as shown in FIG. 4.

This cleaning can prevent contamination by a baker. That is, it is possible to prevent contamination by the baker even when sublimates which are produced upon baking the protective film in the bake step and adhere on the baker are transferred onto the substrate surfaces upon scattering onto the protective film.

This substrate was conveyed to an ArF immersion exposure in-line connected to the coating/developing apparatus via an interface unit to perform immersion exposure. As in the first embodiment, cleaning was performed after immersion exposure and cleaning and drying were performed without leaving any watermarks on the upper and lower surfaces of the substrate. Subsequently, a PEB step, protective film removal step, and development step are performed to form a 55-nm line-and-space pattern free from defects. Finally, a semiconductor device is manufactured by using the semiconductor substrate cleaned as described above.

Although this embodiment has exemplified the case wherein an immersion protective film is present, the uppermost surface in immersion exposure may be a resist without a protective film. In this case, contaminants which can be removed by water washing are sublimates of the resist which are produced in the bake step, and adhere on the baker, scatter onto the resist, and are transferred onto the substrate surfaces.

The following fourth embodiment has an arrangement similar to that of the first embodiment but exemplifies a method of cleaning while accelerating a nozzle toward the outer periphery of a substrate such that a nozzle scan speed Vs is proportional to an angular velocity ωnz (Vs∝ωnz) of the substrate at the nozzle position.

When the protective film had a static contact angle of 78°, the cleaning liquid was ultra-pure water, and the flow rate of the cleaning liquid was set at 0.5 L/min, the hydraulic jump radius of the cleaning liquid discharged from a nozzle is 8 mm. Hence, a scan start position Rs0 was spaced apart from the center by 5 mm, that was proportional to a hydraulic jump radius Rj (Rs0∝Rj).

It suffices to start scanning at a nozzle scan speed Vs=20 mm/s and at the angular velocity of the substrate at a position spaced apart from its outer periphery by 30 mm to clean the substrate surfaces while accelerating the nozzle scan speed. In this case, the cleaning liquid scattered outside the substrate along a trace (31) as shown in FIG. 4. Finally, a semiconductor device is manufactured by using the semiconductor substrate cleaned as described above.

According to this embodiment, it is possible to provide a substrate cleaning method and a semiconductor manufacturing method capable of inexpensively and simply cleaning a processing target substrate without leaving any droplets behind while a lingering cleaning liquid does not impinge on a newly discharged cleaning liquid.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A substrate cleaning method of discharging cleaning liquid from a nozzle above a processing target substrate to clean the substrate while rotating the substrate such that the nozzle is scanned from the center of the substrate toward an outside of the substrate while discharging the cleaning liquid from the nozzle toward the substrate to scatter the cleaning liquid toward the outside of the substrate, comprising;
controlling a flow rate of the cleaning liquid, a rotational speed of the substrate, a scan speed of the nozzle, and a scan start position of the nozzle such that the cleaning liquid discharged from the nozzle does not impinge on the old cleaning liquid remaining on the substrate when the cleaning liquid discharged from the nozzle contacts a surface of the substrate.

2. The method according to claim 1, wherein the flow rate of the cleaning liquid is determined by a radius of a region where the cleaning liquid discharged from the nozzle causes a hydraulic jump phenomenon on the substrate.

3. The method according to claim 1, wherein the scan speed of the nozzle is proportional to a product of the rotational speed of the substrate per unit time and a radius of a region where the cleaning liquid discharged from the nozzle causes a hydraulic jump phenomenon on the substrate.

4. The method according to claim 1, wherein the scan start position of the nozzle is a position which is proportional to a radius of a region where the cleaning liquid discharged from the nozzle causes a hydraulic jump phenomenon on the substrate.

5. The method according to claim 1, wherein the scan start position of the nozzle is a position which is apart from the center of the substrate at a distance smaller than a radius of a region where the cleaning liquid discharged from the nozzle causes a hydraulic jump phenomenon on the substrate.

6. The method according to claim 1, further comprising discharging a cleaning liquid from another nozzle to a lower surface of the substrate.

7. The method according to claim 1, wherein the substrate is a substrate after immersion exposure.

8. The method according to claim 7, wherein the substrate is a substrate on which immersion exposure is performed by an ArF immersion exposure apparatus.

9. The method according to claim 1, wherein the substrate is a substrate before immersion exposure.

10. The method according to claim 1, wherein scanning is performed while increasing the scan speed of the nozzle toward an outer periphery of the substrate.

11. The method according to claim 10, wherein the scan speed is proportional to an angular velocity of the substrate at a position of the nozzle.

12. A semiconductor device manufacturing method of manufacturing a semiconductor device using a processing target substrate which is cleaned by rotating the substrate such that the nozzle is scanned from the center of the substrate toward an outside of the substrate while discharging the cleaning liquid from the nozzle toward the substrate to scatter the cleaning liquid toward the outside of the substrate, comprising;
controlling a flow rate of the cleaning liquid, a rotational speed of the substrate, a scan speed of the nozzle, and a scan start position of the nozzle such that the cleaning liquid discharged from the nozzle does not impinge on the old cleaning liquid remaining on the substrate when the cleaning liquid discharged from the nozzle contacts a surface of the substrate; and
manufacturing the semiconductor device using the cleaned substrate.
